(19) United States
(12) Patent Application Publication
(10) Pub. No.: US 2023/0249014 A1
(43) Pub. Date: Aug. 10, 2023

(54) Self-Tightening Cable Clamp

(71) Applicant: Latchways plc, Devizes (GB)

(72) Inventor: Jacob Thackeray Squire, Devizes (GB)

(21) Appl. No.: 18/001,276

(22) PCT Filed: May 13, 2021
(86) PCT No.: PCT/GB2021/051150

§ 371 Date: Dec. 9, 2022

(30) Foreign Application Priority Data
Jun. 12, 2020 (GB) 2008930.6

(51) Int. Cl. A62B 35/00; F16G 11/10

(52) U.S. Cl. CPC A62B 35/0075; F16G 11/101; A62B 35/0056

(57) ABSTRACT

A clamp for use with a cable or safety includes a receiving member and a jamming member configured to move relative to the receiving member. In use, an end of the safety line is looped around the jamming member. The clamp further may include an actuator, which is adjustable to reconfigure the clamp between: an unlocked state, wherein in the unlocked state the safety line can be moved through the clamp, and a locked state, wherein in the locked state the jamming member is urged into the receiving member. The safety line is thus clamped between the jamming member and at least a portion of the receiving member. The actuator may be a handle and the position of the handle may be manually adjustable. The clamp may include at least one indicator to provide a visual indication of the state of the clamp.

### CROSS-REFERENCE TO RELATED APPLICATION

This application is a U.S. National Stage Application under 35 U.S.C. § 371 of International Patent Application No. PCT/GB2021/051150, filed May 13, 2021, which claims priority to United Kingdom Application No. 2008930.6, filed Jun. 12, 2020, the disclosure of which is incorporated by reference herein in its entirety.

### BACKGROUND

### Technical Field

The present disclosure relates to a clamp or a clamping device for use with a safety line (e.g., cable or rope). In particular, the present disclosure provides an improved clamp for an end of a safety line that is configured to tighten in response to a load applied to the line.

### Technical Considerations

There are many applications in which a cable or safety line is required to be connected between two anchor points. For example, on raised worksites such as roofs a horizontal safety line system is often used minimise the consequences of falls from height. It is not always practical or cost effective to cut the cable to the exact length required for a given project and to connect each end of the cable to a connector (such as a karabiner), particularly if the tension of the cable needs to be adjusted or maintained.

A known solution to this problem is to use a clamp to connect an end of a cable or safety line to an anchor point. An end of the safety line is received into the clamp, pulled to the required length and clamped under tension. A common type of clamp used is a wedge clamp or wedge socket in which an end of the cable is looped around a wedge and the wedge is driven into a socket or clamping member to retain the cable therebetween. Generally, a tool is required to drive the wedge into the clamping position, such as a hammer or a spanner to tighten a bolt.

It is common for the technician or installer to clamp the cable as tightly as possible by forcing the wedge as far as they can into the socket or clamping member. This is to ensure that the cable does come loose from the clamp when in use, which could result in a serious accident.

### SUMMARY

Accordingly, in some non-limiting embodiments or aspects, the present disclosure provides an improved clamp for a cable or safety line that improves safety and reduces maintenance and repair costs. In some non-limiting embodiments or aspects, it is an object of the present disclosure to provide an improved clamp for a cable or safety line that is more convenient and efficient to install or remove. In some non-limiting embodiments or aspects, it is an object of the present disclosure to provide an improved clamp for a cable or safety line that self-tightens under load.

In some non-limiting embodiments or aspects, the present disclosure provides a clamp for use with a safety line which may include a receiving member and a jamming member configured to move relative to the receiving member. In use, an end of the safety line may be looped around the jamming member. The clamp further may include a handle, wherein the position of the handle may be manually adjustable to reconfigure the clamp between: an unlocked state, wherein in the unlocked state the safety line can be moved through the clamp; and a locked state, wherein in the locked state the jamming member is urged into the receiving member, such that the safety line may be clamped between the jamming member and at least a portion of the receiving member.

In some non-limiting embodiments or aspects, the locked state may equivalently be referred to as a first locked state. The clamp may be suitable for use with a cable or a rope. In some non-limiting embodiments or aspects, the handle may be manually adjustable to reconfigure the clamp between the unlocked state and the locked state. In this manner, no tools (such as a hammer, spanner or torque wrench) are required to engage or release the clamp. Thus, the clamp is more convenient and efficient to use, particularly if the clamp is being used at height or in an awkward location.

In some non-limiting embodiments or aspects, the handle may be configured to be manually adjusted (e.g., adjusted by hand without tools) in order to reduce the risk of the user over-tightening the clamp. If the safety line is clamped too tightly between the jamming member and the receiving member (a large clamping force is applied), this increases wear and can damage the safety line and/or clamp. Thus, the clamp reduces maintenance and/or repair costs and improves the safety or reliability of the clamp. In some non-limiting embodiments or aspects, in the unlocked state, the safety line may be inserted or removed from the clamp. The safety line may be pulled or pushed through the clamp to adjust the length or tension of the safety line. In some non-limiting embodiments or aspects, moving the handle in a first direction may move the jamming member towards the locked state and moving the handle in a second direction opposite to first direction may move the jamming member towards the unlocked state.

In some non-limiting embodiments or aspects, the handle may be twisted or rotated to reconfigure the clamp between the unlocked state and the locked state, and vice versa. For example, rotating the handle in a clockwise direction may move the clamp towards the locked state, and rotating the handle in an anti-clockwise direction may move the clamp towards the unlocked state. In some non-limiting embodiments or aspects, the handle may be mounted, or threadedly mounted, on a shaft. The handle may be rotated relative to the shaft to reconfigure the clamp between the unlocked state and the locked state.

In some non-limiting embodiments or aspects, the clamp further may include at least one indicator configured to provide a visual indication of the state of the clamp. This is advantageous as providing a visual indication of when the clamp is in the unlocked state and/or the locked state confirms whether the clamp is safe to use without requiring the user to check the torque of bolts or physically inspect the clamp in any way.

In some non-limiting embodiments or aspects, the clamp may further include a chassis connected to the jamming member. The chassis may be disposed between a first portion of the handle and a second portion of the handle. When moving towards the locked state (e.g., when the handle is moved in the first direction), the first portion of the handle may engage the chassis, thereby exerting a force that urges the chassis and the jamming member towards the receiving member. When moving towards the unlocked state (e.g., when the handle is moved in the second direction), the second portion of the handle may engage the chassis, thereby exerting a force that moves the chassis and the jamming member away from the receiving member.

In some non-limiting embodiments or aspects, in the locked state, the second portion of the handle may be spaced from the chassis. In other words, in the locked state there may be a gap between the chassis and the second portion of the handle, or the chassis is out of engagement with the second portion of the handle. This is advantageous as it may allow the jamming member connected to the chassis to move further into the receiving member if a force is applied with the safety line in the locked state.

In some non-limiting embodiments or aspects, the handle may include an actuator and the second portion of the handle may be a portion of the actuator. The actuator may include a top hat nut. In some non-limiting embodiments or aspects, the jamming member may include an aperture and the chassis may be mounted to the jamming member by a fastener inserted through the aperture. A spacer member (or insert) may be received in the aperture in the jamming member, wherein the chassis is mounted to the jamming member by a fastener member inserted through the spacer member. The spacer member may be a cam spacer. The aperture and optionally the spacer member may allow the jamming member to move or slide relative to the receiving member and/or the shaft.

In some non-limiting embodiments or aspects, the handle may include a housing. The handle may include a nut mounted within the housing, the nut having a body and a projecting rim. This may be referred to as a top hat nut. In some non-limiting embodiments or aspects, the chassis may include an aperture configured to receive the body of the nut therethrough, wherein the projecting rim of the nut cannot pass through the aperture. Thus, the chassis may be mounted between a portion of the housing and the projecting rim of the nut. In some non-limiting embodiments or aspects, when moving towards the unlocked state, the body of the nut may be received through the aperture in the chassis and the projecting rim of the nut may abut or engage the chassis, thereby moving the chassis and the jamming member away from the receiving member.

In some non-limiting embodiments or aspects, the projecting rim of the nut may contact an engagement surface of the chassis. The aperture in the chassis (through which the body of the nut is received) may be provided in the engagement surface of the chassis. In some non-limiting embodiments or aspects, the clamp may include a threaded shaft configured to extend through the aperture in the chassis, wherein the housing and nut are mounted on the threaded shaft. In some non-limiting embodiments or aspects, the clamp may include at least one indicator configured to provide a visual indication that the clamp of when the clamp is in the locked state, or the unlocked state.

In some non-limiting embodiments or aspects, the clamp may include an indicator configured to provide a visual indication of when the clamp is configured such that it can self-tighten in response to a load applied to the safety line. This may be referred to as a first indicator. The first indicator may not be visible, or may only be visible, in the locked state. In some non-limiting embodiments or aspects, the clamp may include a chassis housing connected to the chassis. A portion of the chassis housing may form the first indicator. In the locked state, the handle housing may be arranged to shield or cover the first indicator. In some non-limiting embodiments or aspects, the chassis housing may be made of plastic. The first indicator (or indicator portion of the chassis housing) may be a different colour to the main body of the chassis housing.

In some non-limiting embodiments or aspects, the clamp may include a second indicator configured to provide a visual indication that the clamp is in the locked state. The second indicator may not be visible in the locked state. In other non-limiting embodiments or aspects, the second indicator may only be visible in the locked state. In some non-limiting embodiments or aspects, the second indicator may include a portion of the jamming member aligned with an aperture in the receiving member. The second indicator may include a portion of an insert or spacer mounted to the jamming member that is aligned with an aperture in the receiving member.

In some non-limiting embodiments or aspects, in response to the application of force on the safety line when in the locked state, the jamming member may be urged further into the receiving member into a second locked state. Thus, the clamp may be configured to self-tighten in response to a load applied to the safety line in the locked state. In some non-limiting embodiments or aspects, at least one indicator may be provided to visually indicate that the clamp is in the second locked state. In some non-limiting embodiments or aspects, a first indicator may be visible in the unlocked state and the second locked state, but not the locked state. In some non-limiting embodiments or aspects, a second indicator may be visible only in the unlocked state. The second indicator may be covered or concealed when the clamp is in the locked state and the second locked state.

In some non-limiting embodiments or aspects, a third indicator may be provided. The third indicator may only be visible in the second locked state. The third indicator may include a portion of the jamming member that extends or projects beyond the receiving member in the second locked state. In some non-limiting embodiments or aspects, the jamming member may be slidably mounted to the receiving member. In some non-limiting embodiments or aspects, the receiving member may include a pair of clamping surfaces, wherein the clamping surfaces are arranged to engage the safety line in the locked state. The jamming member and the receiving member may provide a large clamping area to reduce damage to the safety line.

In some non-limiting embodiments or aspects, the jamming member may have a tapered or wedge shape. In some embodiments or aspects, the jamming member may be referred to as a wedge. The wedge may be tapered such that when tension is applied to the safety line in the locked position the wedge is pulled towards the receiving member. The receiving member may be a socket shaped to receive the jamming member or wedge. In some non-limiting embodiments or aspects, the present disclosure provides a clamp for use with a safety line. The clamp may include a receiving member and a jamming member configured to move relative to the receiving member. In use, an end of the safety line may be looped around the jamming member. The clamp further may include a chassis connected to the jamming member and an actuator. The position of the actuator may be adjustable to reconfigure the clamp between: an unlocked state, wherein in the unlocked state the safety line can be moved through the clamp; and a locked state, wherein in the locked state the jamming member is urged into the receiving member, such that the safety line is clamped between the jamming member and at least a portion of the receiving member. To drive the clamp towards the locked state a first portion of the actuator may engage the chassis and to drive the clamp towards the unlocked state a second portion of the actuator engages the chassis. In the locked state, the second portion of the actuator may be spaced from the chassis; and/or in a configuration between the unlocked state and the locked state, both the first and second portions of the actuator may be out of engagement with the chassis. The first portion of the actuator may be arranged to engage the chassis in a first direction of travel, and the second portion of the actuator may be arranged to engage the chassis in a second (reverse) direction of travel.

In some non-limiting embodiments or aspects, an improved clamp for securing an end of a safety line between a jamming member and a receiving member is provided, wherein movement of the jamming member may be controlled by an actuator engaging a chassis. In some non-limiting embodiments or aspects, this arrangement of the chassis and the actuator may allow the jamming member connected to the chassis to move further into the receiving member if a force is applied with the safety line in the locked state. Thus, the clamp may self-tighten. In some non-limiting embodiments or aspects, the position of the actuator may be manually adjustable. In some non-limiting embodiments or aspects, the clamp further may include at least one indicator configured to provide a visual indication of the state of the clamp. The at least one indicator may be as described herein.

In some non-limiting embodiments or aspects, the actuator may include a handle. In some non-limiting embodiments or aspects, the actuator may include a nut having a body and a projecting rim. The second portion of the actuator may be the projecting rim of the nut. In some non-limiting embodiments or aspects, the jamming member may include an aperture and the chassis is mounted to the jamming member by a fastener inserted through the aperture. In some non-limiting embodiments or aspects, a spacer member may be received in the aperture in the jamming member, wherein the chassis may be mounted to the jamming member by a fastener member inserted through the spacer member. The spacer member may be a cam spacer.

In some non-limiting embodiments or aspects, when moving towards the unlocked state, the body of the nut may be received through an aperture in the chassis and the projecting rim of the nut may abut or engage the chassis, thereby moving the chassis and the jamming member away from the receiving member. In some non-limiting embodiments or aspects, the actuator may be mounted on a shaft or a threaded shaft. The shaft may extend through an aperture in the chassis.

In some non-limiting embodiments or aspects, the present disclosure provides a clamp for use with a safety line that may include a receiving member and a jamming member configured to move relative to the receiving member. In use, an end of the safety line may be looped around the jamming member. The clamp further may include an actuator, wherein the position of the actuator may be adjustable to reconfigure the clamp between: an unlocked state, wherein in the unlocked state the safety line can be moved through the clamp; and a locked state, wherein in the locked state the jamming member is urged into the receiving member, such that the safety line is clamped between the jamming member and at least a portion of the receiving member, and at least one indicator configured to provide a visual indication of the state of the clamp.

In some non-limiting embodiments or aspects, the clamp may include at least one indicator configured to provide a visual indication of when the clamp is in the locked state, or the unlocked state. In some non-limiting embodiments or aspects, the at least one indicator may include an indicator that is not visible or only visible when the clamp is in the unlocked state. In some non-limiting embodiments or aspects, the at least one indicator may include an indicator that is not visible or only visible when the clamp is in the locked state. In some non-limiting embodiments or aspects, an indicator may be covered or shielded when the clamp is in the unlocked state or the locked state. In some non-limiting embodiments or aspects, the clamp may include an indicator configured to provide a visual indication of when the clamp is configured such that it can self-tighten in response to a load applied to the safety line. This may be referred to as a first indicator. Self-tighten means that the jamming member may move towards the receiving member in response to a load applied to the safety line.

In some non-limiting embodiments or aspects, the clamp may include a chassis connected to the jamming member. A chassis housing may be connected to the chassis. Optionally, a portion of the chassis housing may form the first indicator. In the locked state, a portion of the actuator may be arranged to shield or cover the first indicator. In some non-limiting embodiments or aspects, the chassis housing may be made of plastic. The first indicator (or indicator portion of the chassis housing) may be a different colour to the main body of the chassis housing.

In some non-limiting embodiments or aspects, the clamp may include a second indicator configured to provide a visual indication that the clamp is in the locked state. The second indicator may be referred to as the locking indicator, as it provides a visual indication that the clamp has been sufficiently tightened to retain the safety line in the clamp. In some non-limiting embodiments or aspects, the second indicator may not be visible in the locked state. In other non-limiting embodiments or aspects, the second indicator may only be visible in the locked state. In some non-limiting embodiments or aspects, the second indicator may include a portion of the jamming member aligned with an aperture in the receiving member. The second indicator may include a portion of an insert or spacer mounted to the jamming member that is aligned with an aperture in the receiving member.

In some non-limiting embodiments or aspects, in response to the application of force on the safety line when in the locked state, the jamming member may be urged further into the receiving member into a second locked state. Thus, the clamp may be configured to self-tighten in response to a load applied to the safety line in the locked state. In some non-limiting embodiments or aspects, at least one indicator may be provided to visually indicate that the clamp is in the second locked state. In some non-limiting embodiments or aspects, a first indicator may be visible in the unlocked state and the second locked state, but not visible in the locked state. In some non-limiting embodiments or aspects, a second indicator may be visible only in the unlocked state. The second indicator may be covered or concealed when the clamp is in the locked state and the second locked state.

In some non-limiting embodiments or aspects, a third indicator may be provided. The third indicator may only be visible in the second locked state. The third indicator may include a portion of the jamming member that extends or projects beyond the receiving member in the second locked state. In some non-limiting embodiments or aspects, the at least one indicator may include a symbol or other optical marker. For example, the at least one indicator may include a label. In some non-limiting embodiments or aspects, the present disclosure provides a horizontal safety line system that may include a clamp as defined herein and a safety line that may include a first end configured to be connected to an anchor point and a second end clamped in the clamp, such that in use the safety line is held under tension.

In some non-limiting embodiments or aspects, the safety line may be rope or a cable. The safety line may be a metal wire rope or a metal wire cable. In some non-limiting embodiments or aspects, the second end of the safety line may include a stop member. The stop member may be configured to prevent the second end of the safety line being removed from the clamp during use. For example, the stop member may be sized such that it cannot be received into the receiving member. In some non-limiting embodiments or aspects, the system may further may include one or more travellers configured to be mounted to the safety line. A user may connect their personal safety line to the one or more travellers to allow them to safely move along the horizontal safety line.

Further non-limiting embodiments or aspects are set forth in the following numbered clauses:

Clause 1: A clamp for use with a safety line comprising: a receiving member; a jamming member configured to move relative to the receiving member wherein, in use, an end of the safety line is looped around the jamming member; and a handle, wherein the position of the handle is manually adjustable to reconfigure the clamp between: an unlocked state, wherein in the unlocked state the safety line can be moved through the clamp; and a locked state, wherein in the locked state the jamming member is urged into the receiving member, such that the safety line is clamped between the jamming member and at least a portion of the receiving member.

Clause 2: The clamp of clause 1, wherein, moving the handle in a first direction moves the jamming member towards the locked state and moving the handle in a second direction opposite to first direction moves the jamming member towards the unlocked state.

Clause 3: The clamp of clause 1 or 2, further comprising at least one indicator configured to provide a visual indication of the state of the clamp.

Clause 4: The clamp of any of clauses 1-3, further comprising a chassis connected to the jamming member.

Clause 5: The clamp of any of clauses 1-4, wherein the chassis is disposed between a first portion of the handle and a second portion of the handle.

Clause 6: The clamp of any of clauses 1-5, wherein when moving towards the locked state, the first portion of the handle engages the chassis thereby exerting a force that urges the chassis and the jamming member towards the receiving member.

Clause 7: The clamp of any of clauses 1-6, wherein when moving towards the unlocked state, the second portion of the handle engages the chassis, thereby exerting a force that moves the chassis and the jamming member away from the receiving member.

Clause 8: The clamp of any of clauses 1-7, wherein in the locked state the second portion of the handle is spaced from the chassis.

Clause 9: The clamp of any of clauses 1-8, wherein the handle comprises an actuator and the second portion of the handle is a portion of the actuator.

Clause 10: The clamp of any of clauses 1-9, wherein the jamming member comprises an aperture and the chassis is mounted to the jamming member by a fastener inserted through the aperture.

Clause 11: The clamp of any of clauses 1-10, further comprising a spacer member received in the aperture in the jamming member, wherein the chassis is mounted to the jamming member by a fastener member inserted through the spacer member.

Clause 12: The clamp of any of clauses 1-11, wherein the handle comprises: a housing and a nut mounted within the housing, the nut having a body and a projecting rim.

Clause 13: The clamp of any one of clauses 1-12, wherein the chassis comprises an aperture configured to receive the body of the nut therethrough, wherein the projecting rim of the nut cannot pass through the aperture.

Clause 14: The clamp of any one of clauses 1-13, wherein when moving towards the unlocked state the body of the nut is received through the aperture in the chassis and the projecting rim of the nut abuts the chassis, thereby moving the chassis and the jamming member away from the receiving member.

Clause 15: The clamp of any of clauses 1-14, further comprising a threaded shaft configured to extend through the aperture in the chassis, wherein the housing and nut are mounted on the shaft.

Clause 16: The clamp of any of any one of clauses 1-15, further comprising a chassis housing, wherein a portion of the chassis housing forms a first indicator, wherein in the locked state the handle housing is arranged to shield or cover the first indicator.

Clause 17: A clamp for use with a safety line comprising: a receiving member; a jamming member configured to move relative to the receiving member wherein, in use, an end of the safety line is looped around the jamming member; a chassis connected to the jamming member; and an actuator, wherein the position of the actuator is adjustable to reconfigure the clamp between: an unlocked state, wherein in the unlocked state the safety line can be moved through the clamp; and a locked state, wherein in the locked state the jamming member is urged into the receiving member, such that the safety line is clamped between the jamming member and at least a portion of the receiving member; wherein to drive the clamp towards the locked state a first portion of the actuator engages the chassis and to drive the clamp towards the unlocked state a second portion of the actuator engages the chassis; wherein: in the locked state the second portion of the actuator is spaced from the chassis; and/or in a configuration between the unlocked state and the locked state both the first and second portions of the actuator are out of engagement with the chassis; and/or the first portion of the actuator is arranged to engage the chassis in a first direction of travel, and the second portion of the actuator is arranged to engage the chassis in a second (reverse) direction of travel.

Clause 18: The clamp of clause 17, wherein the actuator comprises a handle.

Clause 19: The clamp of clause 17 or clause 18, wherein the actuator comprises a nut having a body and a projecting rim.

Clause 20: The clamp of any of clauses 17-19, wherein, in response to the application of force on the safety line when in the locked state, the jamming member is urged further into the receiving member into a second locked state.

Clause 21: The clamp of any of clauses 17-20, further comprising at least one indicator configured to visually indicate that the clamp is in the second locked state.

Clause 22: A clamp for use with a safety line comprising: a receiving member; a jamming member configured to move relative to the receiving member wherein, in use, an end of the safety line is looped around the jamming member; an actuator, wherein the position of the actuator is adjustable to reconfigure the clamp between: an unlocked state, wherein in the unlocked state the safety line can be moved through the clamp; and a locked state, wherein in the locked state the jamming member is urged into the receiving member, such that the safety line is clamped between the jamming member and at least a portion of the receiving member; and at least one indicator configured to provide a visual indication of the state of the clamp.

Clause 23: The clamp of clause 22, wherein the at least one indicator comprises a first indicator configured to provide a visual indication that the clamp can self-tighten in response to a load applied to the safety line.

Clause 24: The clamp of clause 22 or 23, wherein the first indicator is not visible or is only visible when the clamp is in the locked state.

Clause 25: The clamp of any of clauses 22-24, wherein the clamp comprises a chassis connected to the jamming member and a chassis housing, wherein the first indicator comprises a portion of the chassis housing.

Clause 26: The clamp of any of clauses 22-25, wherein the at least one indicator comprises a second indicator configured to provide a visual indication that the clamp is in the locked state, wherein the second indicator is not visible or is only visible in the locked state.

Clause 27: The clamp of any of clauses 22-26, wherein, in response to the application of force on the safety line when in the locked state, the jamming member is urged further into the receiving member into a second locked state.

Clause 28: The clamp of any of clauses 22-27, wherein the at least one indicator comprises a third indicator which is only visible when the clamp is in the second locked state, wherein the third indicator comprises a portion of the jamming member that projects from the receiving member in the second locked state.

Clause 29: The clamp of any of clauses 22-28, wherein the actuator comprises a handle, wherein the position of the handle is manually adjustable to reconfigure the clamp between the unlocked state and the locked state.

Clause 30: The clamp of any of clauses 22-29, wherein the jamming member is slidably mounted to the receiving member.

Clause 31: The clamp of any of clauses 22-30, wherein the receiving member comprises a pair of clamping surfaces, wherein the clamping surfaces are arranged to engage the safety line in the locked state.

Clause 32: The clamp of any of clauses 22-31, wherein the jamming member has a tapered or wedge shape.

Clause 33: The clamp of any of clauses 22-32, wherein the receiving member is a socket shaped to receive the jamming member.

Clause 34: A horizontal safety line system comprising: a clamp of any of clauses 22-33; and a safety line comprising a first end configured to be connected to an anchor point and a second end clamped in the clamp, such that in use the safety line is held under tension.

Clause 35: The horizontal safety line system of clause 34, wherein the safety line is a metal wire rope or a metal wire cable.

Clause 36: The horizontal safety line system of clause 34 or 35, wherein the second end of the safety line comprises a stop member arranged to prevent the safety line being removed from the clamp during use.

Clause 37: A clamp for use with a safety line, the clamp comprising: a receiving member; a jamming member movably mounted relative to the receiving member, wherein, in use, an end of the safety line is looped around the jamming member; an actuator configured for moving the jamming member relative to the receiving member, wherein the actuator is movable to reconfigure the clamp between: an unlocked state in which the safety line is movable between the receiving member and the jamming member; and a locked state in which the safety line is clamped between the jamming member and at least a portion of the receiving member; and at least one indicator configured to provide a visual indication of the unlocked state or the locked state of the clamp.

Clause 38: The clamp of clause 37, wherein the at least one indicator comprises a first indicator configured to provide a visual indication that the clamp can self-tighten in response to a load applied to the safety line.

Clause 39: The clamp of clause 37 or 38, wherein the first indicator is visible or concealed when the clamp is in the locked state.

Clause 40: The clamp of any of clauses 37-39, wherein the at least one indicator comprises a colored portion that is a different color compared to remaining portions of the clamp.

Clause 41: The clamp of any of clauses 37-40, wherein the clamp comprises a chassis connected to the jamming member and a chassis housing, wherein the first indicator is formed on a portion of the chassis housing.

Clause 42: The clamp of any of clauses 37-41, wherein the at least one indicator comprises a second indicator configured to provide a visual indication that the clamp is in the locked state, wherein the second indicator is visible or concealed in the locked state.

Clause 43: The clamp of any of clauses 37-42, wherein, in response to the application of force on the safety line in the locked state, the jamming member is urged further into the receiving member into a second locked state.

Clause 44: The clamp of any of clauses 37-43, wherein the actuator comprises a handle, and wherein the handle is rotatable to reconfigure the clamp between the unlocked state and the locked state.

Clause 45: The clamp of any of clauses 37-44, wherein rotational movement of the handle results in a sliding movement of the jamming member relative to the receiving member.

Clause 46: The clamp of any of clauses 37-45, wherein the jamming member is slidably mounted to the receiving member.

Clause 47: The clamp of any of clauses 37-46, wherein the receiving member comprises a pair of clamping surfaces, wherein the clamping surfaces are arranged to engage the safety line in the locked state.

Clause 48: The clamp of any of clauses 37-47, wherein the jamming member has a tapered or wedge shape.

Clause 49: The clamp of any of clauses 37-48, wherein the jamming member has a notched or a toothed surface on two sides of the tapered or wedge shape.

Clause 50: A horizontal safety line system comprising: a clamp comprising: a receiving member; a jamming member movably mounted relative to the receiving member, wherein, in use, an end of the safety line is looped around the jamming member; an actuator configured for moving the jamming member relative to the receiving member, wherein the actuator is movable to reconfigure the clamp between: an unlocked state in which the safety line is movable between the receiving member and the jamming member; and a locked state in which the safety line is clamped between the jamming member and at least a portion of the receiving member; and a safety line comprising a first end configured to be connected to an anchor point and a second end clamped between the receiving member and the jamming member, wherein the clamp, in the locked state, is configured to self-tighten the safety line in response to a load applied to the safety line.

Clause 51: The horizontal safety line system of claim 50, wherein the safety line is a metal wire rope or a metal wire cable.

Clause 52: The horizontal safety line system of claim 50 or 51, wherein the second end of the safety line comprises a stop member arranged to prevent the safety line being removed from the clamp during use.

Clause 53: The horizontal safety line system of any of clauses 50-52, further comprising one or more travellers arranged on the safety line, wherein each of the one or more travellers is configured for connecting to a personal safety line connected to a user.

Clause 54: The horizontal safety line system of any of clauses 50-53, further comprising at least one indicator configured to provide a visual indication of the unlocked state or the locked state of the clamp.

Clause 55: The horizontal safety line system of any of clauses 50-54, wherein the at least one indicator comprises a first indicator configured to provide a visual indication that the clamp can self-tighten in response to a load applied to the safety line.

Clause 56: The horizontal safety line system of any clauses 50-55, wherein the first indicator is visible or concealed when the clamp is in the locked state.

### BRIEF DESCRIPTION OF THE DRAWINGS

Illustrative embodiments of the disclosure will now be described, by way of example only, in relation to the accompanying drawings, in which:

FIG. 1 is an exploded view of an embodiment of a clamp according to some non-limiting embodiments or aspects of the present disclosure;

FIG. 2 is a side view of the clamp of FIG. 1 when assembled and in an unlocked state;

FIG. 3 is an internal cross section of the clamp of FIG. 2 in the unlocked state including a safety line;

FIG. 4 is side view of the clamp of FIG. 2 moving from the unlocked state towards the locked state;

FIG. 5 is an internal cross section of the clamp of FIG. 4 in a configuration between the unlocked state and the locked state;

FIG. 6 is a side view of the clamp of FIG. 1 when assembled and in a locked state;

FIG. 7 is an internal cross section of the clamp of FIG. 6 in the locked state;

FIG. 8 is a side view of the clamp of FIG. 6 when in a second locked state;

FIG. 9 is an internal cross section of the clamp of FIG. 8 in the second locked state; and

FIG. 10 is a schematic illustration of a horizontal safety line system including the clamp as shown in FIGS. 1-9.

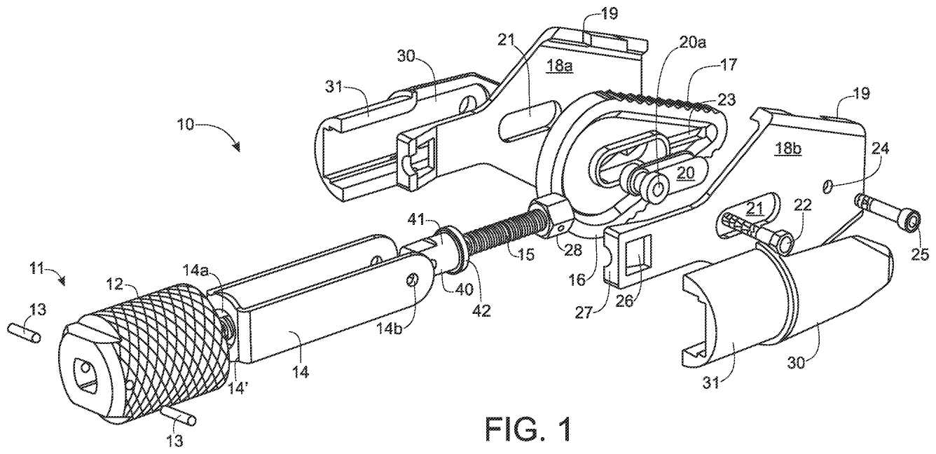

It will be appreciated that FIGS. 1-10 are schematic drawings and features are not necessarily drawn to scale.

### DETAILED DESCRIPTION

As used herein, the singular form of “a”, “an”, and “the” include plural referents unless the context clearly dictates otherwise. Spatial or directional terms, such as “left”, “right”, “inner”, “outer”, “above”, “below”, and the like, relate to the embodiments or aspects as shown in the drawing figures and are not to be considered as limiting as the embodiments or aspects can assume various alternative orientations. All numbers used in the specification and claims are to be understood as being modified in all instances by the term “about” or “approximately”. By “about” or “approximately” is meant within plus or minus twenty-five percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements. All documents referred to herein are “incorporated by reference” in their entirety. The term “at least” is synonymous with “greater than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C. The word “comprising” and “comprises”, and the like, does not exclude the presence of elements or steps other than those listed in any claim or the specification as a whole. In the present specification, “comprises” means “includes” and “comprising” means “including”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values. As used herein, the terms “perpendicular”, “transverse”, “substantially perpendicular”, or “substantially transverse” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

The discussion of various embodiments or aspects may describe certain features as being “particularly” or “preferably” within certain limitations (e.g., “preferably”, “more preferably”, or “even more preferably”, within certain limitations). It is to be understood that the disclosure is not limited to these particular or preferred limitations but encompasses the entire scope of the various embodiments and aspects described herein. The disclosure comprises, consists of, or consists essentially of, the following embodiments or aspects, in any combination. Various embodiments or aspects of the disclosure are illustrated in separate drawing figures. However, it is to be understood that this is simply for ease of illustration and discussion. In the practice of the disclosure, one or more embodiments or aspects shown in one drawing figure can be combined with one or more embodiments or aspects shown in one or more of the other drawing figures.

FIG. 1 shows an exploded view of a clamp 10 in accordance with some non-limiting embodiments or aspects of the present disclosure.

The clamp 10 includes a jamming member 16. In some non-limiting embodiments or aspects, the jamming member 16 is a wedge having a tapered shape. It will be appreciated that jamming members 16 having other shapes may be used.

In some non-limiting embodiments or aspects, the jamming member 16 has a notched or toothed surface 17 on both sides of the wedge. The jamming member 16 is configured to be inserted into a receiving member 18. In some non-limiting embodiments or aspects, the receiving member 18 is formed of two segments 18a, 18b. The receiving member 18 includes clamping blocks or clamping surfaces 19. In use, an end of a safety line is looped around the jamming member 16 and the safety line is clamped between the toothed surface 17 and the clamping surface 19 of the receiving member 18. This type of clamp is sometimes referred to as a wedge socket.

In some non-limiting embodiments or aspects, the clamp 10 includes a handle 11 having a housing 12. The housing 12 may have a textured outer surface to improve grip. It will be appreciated that, in some non-limiting embodiments or aspects, the handle 11 may be replaced by a different actuator mechanism.

In some non-limiting embodiments or aspects, a top hat nut 40 is mounted to the housing 12 by a pair of pins 13. The housing 12 and the top hat nut 40 are threadedly mounted on a shaft 15. The top hat nut 40 includes a body 41 and a projecting rim 42. The body 41 of the top hat nut 40 is received through an aperture 14a in a top or engagement surface 14′ of a chassis or frame 14.

It will be appreciated that the present disclosure is not limited to the use of a top hat nut 40. Other actuators could be used in place of the top hat nut 40.

In some non-limiting embodiments or aspects, the jamming member 16 further includes an opening into which a spacer member 20 is inserted. Each segment 18a, 18b of the receiving member 18 includes an opening 21 configured to be aligned with the spacer member 20. In some non-limiting embodiments or aspects, the chassis 14 is connected to the jamming member 16 by a fastener (e.g., bolt) 22. The fastener 22 is inserted through apertures 14b, openings 21 and the aperture 20a in the spacer member 20. Thus, movement of the chassis 14 results in movement of the jamming member 16 relative to the receiving member 18.

In some non-limiting embodiments or aspects, the jamming member 16 further includes an additional slot 23. A fastener (e.g., bolt) 25 is inserted through the slot 23 and through apertures 24 in the receiving member 18a 18b. Thus, the jamming member 16 is slidably mounted to the receiving member 18.

In some non-limiting embodiments or aspects, a nut 28 is mounted on the threaded shaft 15. The nut 28 is preferably not a top-hat nut. The nut 28 is received into the square apertures 26 in the receiving member 18a, 18b. As such, the nut 28 prevents the threaded shaft 15 from rotating and sliding relative to the receiving member 18. In some non-limiting embodiments or aspects, the nut 28 may be fixed in position on the threaded shaft 15 by a pin or similar fastener (not shown).

In some non-limiting embodiments or aspects, a chassis housing 30 is arranged to encase or house the chassis 14. The chassis housing 30 includes an indicator portion 31. As detailed below, the indicator portion 31 of the chassis housing is not visible when the clamp 10 is in the locked state. The indicator portion 31 may be referred to as a first indicator. The indicator portion 31 may be a different colour to the remainder of the chassis housing 30. In some non-limiting embodiments or aspects, the chassis housing 30 may be made of plastic to reduce the weight of the clamp 10.

In use, the handle 11 is twisted or rotated relative to the shaft 15 to reconfigure the clamp 10 between an unlocked state, in which a cable or safety line can be inserted into or removed from the clamp, and a locked state in which the cable or safety line is retained between the jamming member 16 and the receiving member 18.

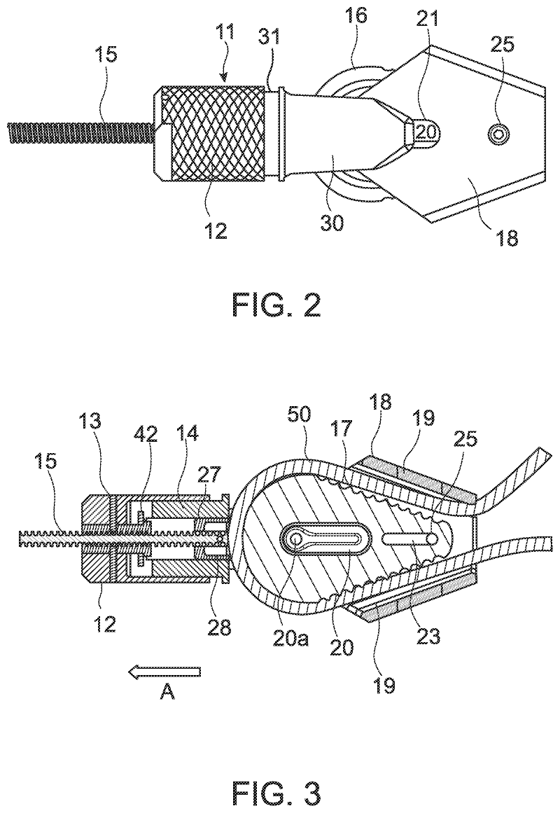

FIG. 2 shows the clamp 10 in the unlocked state. The first indicator 31 is visible, as it extends beyond the handle housing 12. In this non-limiting embodiment or aspect, the first indicator 31 is only visible (by an external user when the clamp 10 is assembled) in the unlocked and second locked states. If the first indicator 31 is visible this means that the clamp 10 cannot self-tighten (e.g., the jamming member 16 cannot move further towards the receiving member 18) when a load is applied to the safety line. If the first indicator 31 is not visible this means that the clamp 10 can self-tighten when a load is applied to the safety line. Thus, the first indicator 31 may be referred to as the self-tightening indicator.

In addition, in the unlocked state as shown in FIG. 2, a portion of the slot 21 in the receiving member 18 is also visible adjacent the chassis housing 30. The slot 21 displays a portion 20 of the spacer member therethrough. The slot 21 and spacer member 20 form a second indicator. In this embodiment, the second indicator 21, 20 is only visible in the unlocked state. Thus, the second indicator 21, 20 provides a visual indication that the clamp needs to be tightened in order to retain the safety line in the clamp.

As both the first indicator 31 and the second indicator 20, 21 are visible, this provides visible confirmation that the clamp 10 is in the unlocked state.

FIG. 3 shows a cross section through the clamp in FIG. 2 when in use with a safety line 50, to allow the configuration of the internal parts to be seen. The safety line 50 is looped around the jamming member 16, such that the safety line 50 contacts the toothed surface 17 and extends around the periphery of the jamming member 16. In the unlocked state as shown, the safety line 50 is not compressed between the jamming member 16 and the clamping surfaces 19 of the receiving member. The safety line 50 can therefore be pulled through the clamp 10 in the unlocked state, to adjust the length or tension of the safety line 50.

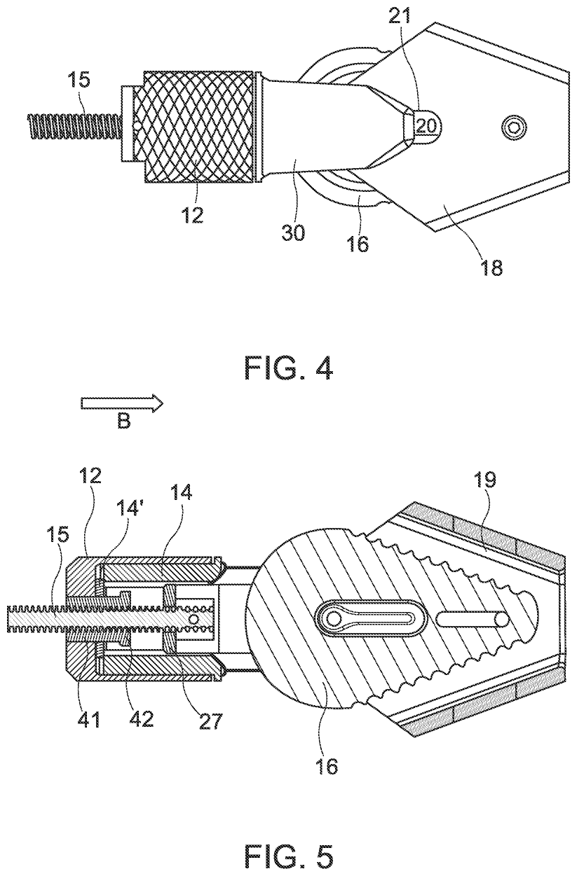

The safety line 50 is omitted from FIGS. 4-9 to allow the relative position of the jamming member 16 and the receiving member 18 to be seen more clearly.

In the unlocked state, the handle 11 has been rotated to move the handle 11, including housing 12 and the top hat nut 40, along the threaded shaft 15 in the direction shown by arrow A. There is a gap between the handle housing 12 and the top (or engagement surface) 14′ of the chassis 14. The rim 42 of the top hat nut 40 does not fit through the aperture 14a in the chassis 14. Thus, when the rim 42 of the top hat nut 40 abuts the chassis 14, further movement of the handle 11 pulls the chassis 14 in the direction shown by arrow A, thereby sliding the jamming member 16 away from the receiving member 18.

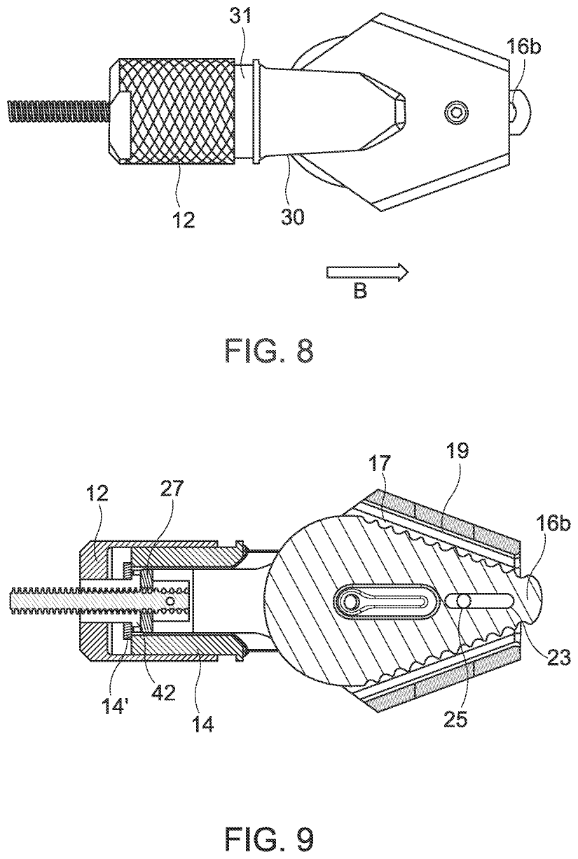

In some non-limiting embodiments or aspects, movement of the chassis 14 and jamming member 16 relative to the receiving member 18 is limited by the length of the slot 23. When the fastener 25 contacts the end of the slot 23 (as shown in FIG. 3) then further movement of the chassis 14 and jamming member 16 in the direction shown by arrow A is prevented. In some non-limiting embodiments or aspects, to secure the safety line 50 in the clamp 10 the handle 11 must be rotated in the opposite direction to move the reconfigure the clamp into the locked state, as shown in FIGS. 4 and 7. In some non-limiting embodiments or aspects, rotation of the handle 11 can be done manually and does not require the use of any tools. This makes it easier and quicker to assemble and set-up.

FIGS. 4-5 show the clamp 10 transitioning from the unlocked state in FIG. 2 towards the locked state. In other words, FIGS. 4-5 illustrate the clamp 10 in a configuration between the fully unlocked state and the locked state. The handle 11, including housing 12 and top hat nut 40, has been moved along the threaded shaft 15 in the direction shown by arrow B. The handle 11 has been rotated until the housing 12 covers or conceals the first indicator 31 (see FIG. 4). However, the second indicator 21, 20 is still visible. This is because the chassis 14 and the jamming member 16 have not moved from the position shown in FIGS. 2 and 3. In some non-limiting embodiments or aspects, there is a configuration between the locked state and the unlocked state (or between FIGS. 3 and 5) in which neither the handle housing 12 nor the rim 42 of the top hat nut are in engagement with the chassis 14.

As shown in FIG. 5, there is no longer a gap between the handle housing 12 and the top 14′ of the chassis. The handle housing 12 has moved along the shaft 15 until it abuts or engages the top 14′ of the chassis 14. The body 41 of the top hat nut 40 has moved through aperture 14a in the chassis along the shaft 15. There is a gap or space between the rim 42 of the top hat nut and the top 14′ of the chassis. There is also a gap or space between the rim 42 of the top hat nut and the end 27 of the receiving member 18 adjacent to the nut 28.

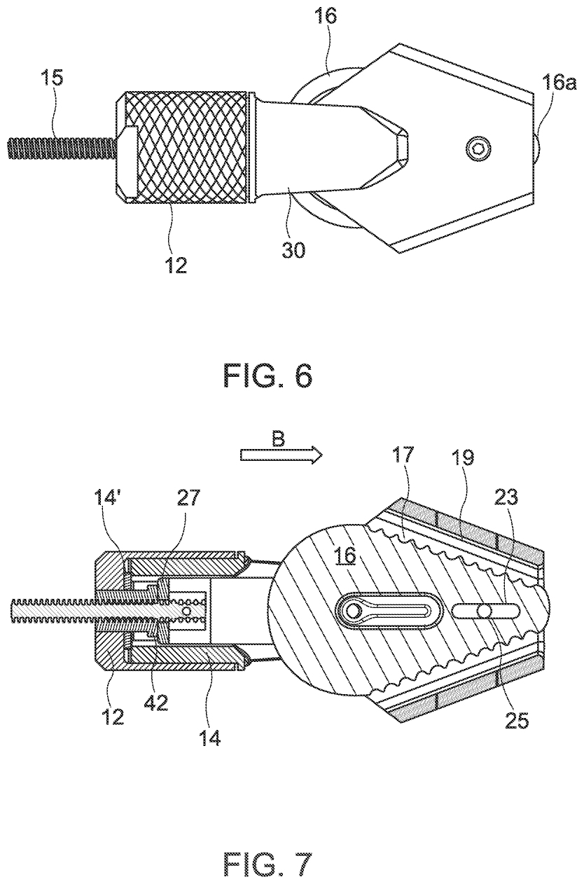

In this configuration, the first indicator 31 is not visible but the second indicator 20, 21 is visible. This confirms to the user the chassis 14 can move if a load is applied to the safety line 50, but the safety line would not be retained in the clamp 10. The handle 11 needs to be turned further in order to secure reconfigure the clamp 10 into the locked state, as shown in FIGS. 6 and 7. FIGS. 6 and 7 show the clamp 10 in the locked state in which the safety line (not shown) is securely clamped between the toothed surface 17 of the jamming member 16 and the clamping surfaces 19 of the receiving member 18.

From the configuration shown in FIGS. 4 and 5, the handle 11 has been further rotated to move the handle housing 12 and top-hat nut 40 along the shaft 15 in the direction shown by arrow B. As the housing 12 contacts the top 14′ of the chassis 14, this further movement of the handle housing 12 starts to push the chassis in the direction shown by arrow B. The movement of the chassis 14 causes the slot 23 of the jamming member 16 to slide relative to the receiving member 18 bringing the toothed surface 17 of the jamming member 17 closer to the clamping surface 19, thereby securely clamping the safety line therebetween (not shown). In some non-limiting embodiments or aspects, the large clamping area reduces damage to the safety line when in the locked state.

In addition, the movement of the chassis 14 results in movement of the chassis housing 30 in direction B. The user rotates the handle 11 until the chassis housing 30 covers or conceals the second indicator 21, 20. Thus, in the locked state neither the first indicator 31 nor the second indicator 21, 20 should be visible. In some non-limiting embodiments or aspects, the indicators 31, 21, 20 provide visual indication that the clamp 10 is safe to use without requiring the user to check the torque of bolts or physically inspect the clamp 10 in any way.

If the clamp 10 cannot reach the locked state (according to the visual indicators) despite proper installation, then it would be an indicator to the user that the clamp 10 should be serviced. In some non-limiting embodiments or aspects, the clamp 10 is designed to be reused many times without service over its lifetime.

As shown in FIG. 7, in the locked state, the fastener 25 does not abut the end of the slot 23. Thus, in the locked state movement of the jamming member 16 is not limited by the slot 23. Instead, in the locked state the projecting rim 42 of the top hat nut 40 engages the end 27 of the receiving member adjacent to the nut 28 received in the square aperture 26 in the receiving member. This contact prevents further movement of the handle 11 along the shaft 15. Thus, the end 27 of the receiving member 18 acts as a stop member to limit movement of the handle 11 and limit the clamping force applied to the safety line.

In some non-limiting embodiments or aspects, in the locked state there is a gap or spacing between the top 14′ (or engagement surface) of the chassis 14 and the rim 42 of the top hat nut 40. This gap allows the chassis 14 to move with the jamming member 16 into the second locked state (in FIGS. 6 and 7).

In some non-limiting embodiments or aspects, the locked state (shown in FIGS. 6 and 7) is the normal operating state of the clamp 10. As described above, the configuration of the handle housing 12, top hat nut 40 and the chassis 14 prevents the clamp 10 from being overtightened in the locked state, thereby reducing damage or wear to the clamp and/or safety line. In some non-limiting embodiments or aspects, when a force is applied to the safety line 50 which is secured in the clamp 10 in the locked state, such as in a fall arrest event, this causes the clamp 10 to self-tighten to the second locked state (see FIGS. 8 and 9). In some non-limiting embodiments or aspects, the force or load applied to the safety line 50 looped around the jamming member 16 pulls the jamming member 16 and consequently the chassis 14 connected thereto in the direction shown by arrow B relative to the receiving member 18. This results in movement of the jamming member 16 closer to the clamping surface 19, thereby increasing the clamping force applied to the safety line 50.

In some non-limiting embodiments or aspects, there is no movement of the handle 11 between the locked state and the second locked state (e.g., between FIG. 6 and FIG. 8). Thus, the chassis 14 and the chassis housing 30 move relative to the handle 11, including housing 12 and top hat nut 40, in direction B. There is no gap between the top 14′ of the chassis and the rim 42 of the top hat nut in the second locked state. This motion of the chassis 14 and chassis housing 30 causes the first indicator 31 to at least partially project beyond the handle housing 12 in the second locked state. In some non-limiting embodiments or aspects, a further indicator that the clamp 10 is in the second locked state is that an additional portion 16b of the jamming member 16 projects from an end of the receiving member 18. This portion 16b may be referred to as a third indicator.

In FIGS. 1-9, the jamming member 16 is a wedge having an apex 16b opposite a curved end. In some non-limiting embodiments or aspects, the chassis 14 and handle 11 are disposed adjacent the curved end of the wedge. However, it will be appreciated that the clamp structure could be reversed, such that the chassis 14 and handle 11 are disposed on the other side of the wedge adjacent to the apex 16b. In this non-limiting embodiment or aspect, the chassis 14 would push the wedge 16 into the unlocked state (in direction A) and pull the wedge 16 into the locked state (in direction B). As such, a push force described above may become a pull force. It is intended that both non-limiting embodiments or aspects are within the scope of the claimed disclosure.

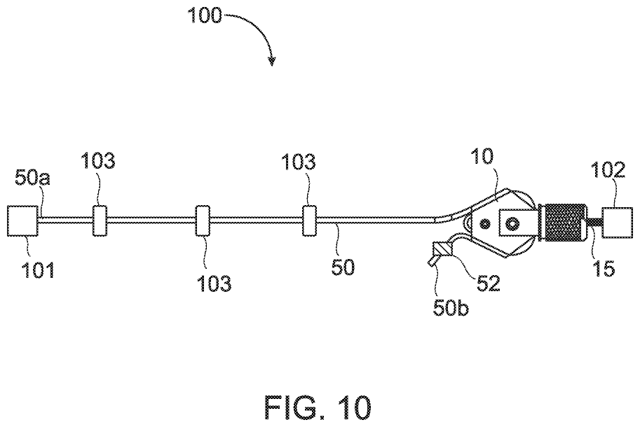

In this alternative non-limiting embodiment or aspect, the second indicator 20, 21 may be visible in the locked state, but not visible in the unlocked state or the second locked state. Similarly, it may be that if the first indicator 31 is visible this means that the clamp 10 can self-tighten when a load is applied to the safety line. Thus, the first indicator 31 may only be visible in the locked state. In some non-limiting embodiments or aspects, the clamp 10 shown in FIGS. 1-9 may be used in a horizontal safety line system 100, as shown schematically in FIG. 10. It will be appreciated that FIG. 10 is not shown to scale and is for illustrative purposes only. In some non-limiting embodiments or aspects, the horizontal safety line system 100 includes a safety line 50, preferably a metal cable. A first end 50a of the safety line 50 may be attached via a connector, such as a karabiner clip, to an anchor point 101. A second end 50b of the safety line 50 is received in the clamp 10.

In some non-limiting embodiments or aspects, a stop member 52 is attached to the second end of the safety line 50b after the safety line 50 has been inserted into the clamp 10. The stop member 52 is configured to prevent the safety line 50 being removed from the clamp 10, as the stop member 52 cannot pass through. Thus, the stop member is a safety feature that prevents the safety line 50 from accidentally being disengaged from the clamp 10. With continued reference to FIG. 10, the clamp 10 is in the locked state. The shaft 15 of the clamp 10 may be connected to via a karabiner or other connector to a second anchor point 102. Thus, the safety line 50 is held under tension without the need to cut the safety line 50 to the desired length between the anchor points 101, 102. In some non-limiting embodiments or aspects, a plurality of travellers 103 are mounted to the safety line 50. A user may connect their personal safety line to one of the travellers 103 to securely move along the safety line 50. If one of the users falls, then the force applied to the traveller 103 will move the clamp 10 into the second locked state, thereby ensuring that the safety line 50 remains under tension.

It will be appreciated that the present disclosure is not limited to use in horizontal safety line systems.

The non-limiting embodiments or aspects of the present disclosure have been described in detail herein. However, it will be appreciated by those skilled in the art that various modifications and alternatives to the embodiments or aspects may be made without departing from the concepts disclosed in the foregoing description. Such modifications are to be considered as included within the following claims unless the claims, by their language, expressly state otherwise. Accordingly, the particular embodiments or aspects described in detail hereinabove are illustrative only and are not limiting as to the scope of the disclosure, which is to be given the full breadth of the appended claims and any and all equivalents thereof.

1-76. (canceled)

77. A clamp for use with a safety line, the clamp comprising: a receiving member;
a jamming member movably mounted relative to the receiving member, wherein, in use, an end of the safety line is looped around the jamming member;
an actuator configured for moving the jamming member relative to the receiving member, wherein the actuator is movable to reconfigure the clamp between:
an unlocked state in which the safety line is movable between the receiving member and the jamming member; and
a locked state in which the safety line is clamped between the jamming member and at least a portion of the receiving member; and
at least one indicator configured to provide a visual indication of the unlocked state or the locked state of the clamp.

78. The clamp of claim 77, wherein the at least one indicator comprises a first indicator configured to provide a visual indication that the clamp can self-tighten in response to a load applied to the safety line.

79. The clamp of claim 78, wherein the first indicator is visible or concealed when the clamp is in the locked state.

80. The clamp of claim 77, wherein the at least one indicator comprises a colored portion that is a different color compared to remaining portions of the clamp.

81. The clamp of claim 77, wherein the clamp comprises a chassis connected to the jamming member and a chassis housing, wherein the first indicator is formed on a portion of the chassis housing.

82. The clamp of claim 77, wherein the at least one indicator comprises a second indicator configured to provide a visual indication that the clamp is in the locked state, wherein the second indicator is visible or concealed in the locked state.

83. The clamp of claim 77, wherein, in response to the application of force on the safety line in the locked state, the jamming member is urged further into the receiving member into a second locked state.

84. The clamp of claim 77, wherein the actuator comprises a handle, and wherein the handle is rotatable to reconfigure the clamp between the unlocked state and the locked state.

85. The clamp of claim 84, wherein rotational movement of the handle results in a sliding movement of the jamming member relative to the receiving member.

86. The clamp of claim 77, wherein the jamming member is slidably mounted to the receiving member.

87. The clamp of claim 77, wherein the receiving member comprises a pair of clamping surfaces, wherein the clamping surfaces are arranged to engage the safety line in the locked state.

88. The clamp of claim 77, wherein the jamming member has a tapered or wedge shape.

89. The clamp of claim 77, wherein the jamming member has a notched or a toothed surface on two sides of the tapered or wedge shape.

90. A horizontal safety line system comprising:
a clamp comprising:
a receiving member;
a jamming member movably mounted relative to the receiving member, wherein, in use, an end of the safety line is looped around the jamming member;
an actuator configured for moving the jamming member relative to the receiving member, wherein the actuator is movable to reconfigure the clamp between:
an unlocked state in which the safety line is movable between the receiving member and the jamming member; and
a locked state in which the safety line is clamped between the jamming member and at least a portion of the receiving member; and
a safety line comprising a first end configured to be connected to an anchor point and a second end clamped between the receiving member and the jamming member,
wherein the clamp, in the locked state, is configured to self-tighten the safety line in response to a load applied to the safety line.

91. The horizontal safety line system of claim 90, wherein the safety line is a metal wire rope or a metal wire cable.

92. The horizontal safety line system of claim 90, wherein the second end of the safety line comprises a stop member arranged to prevent the safety line being removed from the clamp during use.

93. The horizontal safety line system of claim 90, further comprising one or more travellers arranged on the safety line, wherein each of the one or more travellers is configured for connecting to a personal safety line connected to a user.

94. The horizontal safety line system of claim 90, further comprising at least one indicator configured to provide a visual indication of the unlocked state or the locked state of the clamp.

95. The horizontal safety line system of claim 90, wherein the at least one indicator comprises a first indicator configured to provide a visual indication that the clamp can self-tighten in response to a load applied to the safety line.

96. The horizontal safety line system of claim 95, wherein the first indicator is visible or concealed when the clamp is in the locked state.
